(19) United States
(12) Patent Application Publication
(10) Pub. No.: US 2015/0352987 A1
(43) Pub. Date: Dec. 10, 2015

(54) CONTROL SYSTEM FOR A SEAT

(71) Applicant: Caterpillar Inc., Peoria, IL (US)

(72) Inventors: Sean A. Randleman, East Peoria, IL (US); Steven D. Wetherell, East Peoria, IL (US)

(73) Assignee: Caterpillar Inc., Peoria, IL (US)

(21) Appl. No.: 14/827,321

(22) Filed: Aug. 15, 2015

(51) Int. Cl. B60N 2/44

(52) U.S. Cl. CPC B60N 2/442; B60N 2002/4425

(57) ABSTRACT

A control system for a seat having a base portion and a back portion is disclosed. The control system includes a holder coupled to the back portion. The control system includes a control pod removably and at least partially received within the holder. The control pod includes a body and at least one switch disposed on the body. The at least one switch is manually actuatable to control a corresponding component of the seat. The control pod is adapted to be moved between a storage position and a usage position. The control pod is at least partially received within the holder in the storage position. The control pod is outside and spaced apart form the holder in the usage position. The control system includes a cable tethering the seat and the control pod together.

### TECHNICAL FIELD

The present disclosure relates to a control system for controlling a component of a seat.

### BACKGROUND

During various on-highway and off-highway operations, an operator remains seated for extended periods of time while controlling operation of a machine. Therefore, seats are manufactured with various systems, such as height adjustment system, seat suspension system, and the like. Such systems permit the operator to perform tasks comfortably. Typically, such systems are controlled with electric switches that are located on a seat chassis. However, due to space constraints within an operator cabin of the machine, the switches may not be readily visible or accessible to the operator.

U.S. Pat. No. 5,697,110 (the '110 patent) discloses a control scheme for controlling a transporter used in hospitals. The control scheme has a lifting mechanism, a pivoting mechanism, and a swivel mechanism. The control scheme includes a power source. The control scheme further includes a power distribution block for distributing power from the power source and a controller for receiving power from the power block. The controller controls the motor function of one or more of the lifting mechanism, the pivoting mechanism and the swivel mechanism. However, the control panel disclosed in the '110 patent may not be easily accessible to an occupant of the transporter.

### SUMMARY OF THE DISCLOSURE

In one aspect of the present disclosure, a control system for a seat having a base portion and a back portion is provided. The control system includes a holder coupled to the back portion of the seat. The control system also includes a control pod removably and at least partially received within the holder. The control pod includes a body. The control pod also includes at least one switch disposed on the body. The at least one switch is manually actuatable to control a corresponding component of the seat. Further, the control pod is adapted to be moved between a storage position and a usage position. The control pod is at least partially received within the holder in the storage position. The control pod is outside and spaced apart form the holder in the usage position. The control system also includes a cable tethering the control pod and the seat together. Further, a maximum length of the cable defines the usage position of the control pod with respect to the seat.

### BRIEF DESCRIPTION OF THE DRAWINGS

FIG. 1 illustrates a perspective view of a seat within a cabin of a machine having a control system, according to an embodiment of the present disclosure;

FIG. 2 illustrates a side view of the seat of FIG. 1 with a control pod of the control system in a storage position, according to an embodiment of the present disclosure;

FIG. 3 illustrates a side view of the seat of FIG. 1 with the control pod in a usage position, according to an embodiment of the present disclosure; and

FIG. 4 illustrates a front view of the control pod of the control system, according to an embodiment of the present disclosure.

### DETAILED DESCRIPTION

Reference will now be made in detail to specific embodiments or features, examples of which are illustrated in the accompanying drawings. Wherever possible, corresponding or similar reference numbers will be used throughout the drawings to refer to the same or corresponding parts.

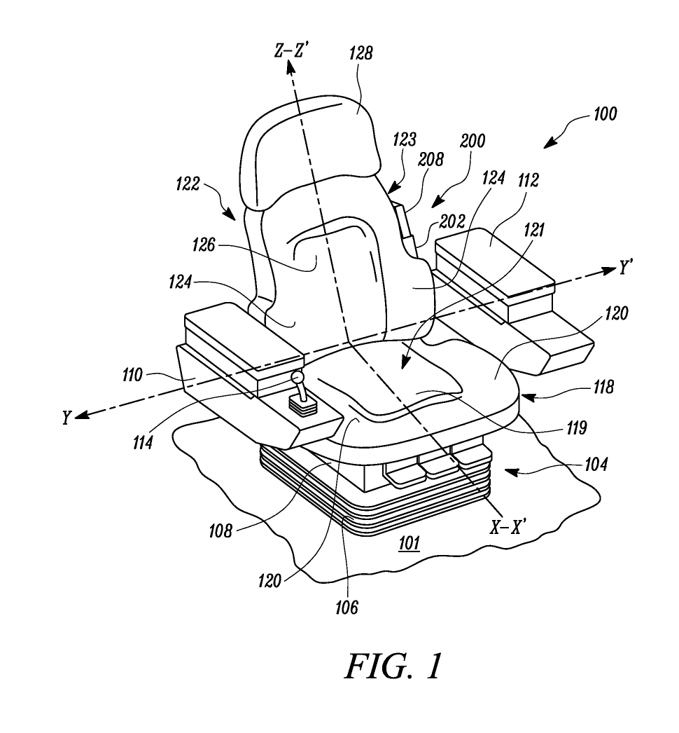

FIG. 1 shows a perspective view of a seat 100 having a control system 200, according to an embodiment of the present disclosure. The seat 100 may be disposed in an operator cabin (not shown) of a machine (not shown) such that an operator seated on the seat 100 may control various machine operations, for example, use of an implement, machine travel and the like. The seat 100 may be used in dump trucks, haul trucks, off highway trucks or any other machine related to various industries like mining, forestry, waste management, construction, agriculture, transportation etc. Alternatively, the seat 100 may also be used to provide a simulating environment of a real time operation of a machine and impart training to prospective operators.

In the illustrated embodiment, the seat 100 is supported on a support assembly 104 coupled to a frame 101 of the operator cabin of the machine. The support assembly 104 includes a support member 106 configured to dampen vibrations transmitted from the machine to the seat 100. The support member 106 may include a suspension system (not shown) for absorbing vibrations imparted to the seat 100. Such suspension system may include springs, bellows, and the like. Further, the support member 106 may also be configured to move the seat 100 along a vertical axis ZZ′. The support assembly 104 may include a lever (not shown) configured to adjust a height of the seat 100 such that an operator seated may have an optimum visibility of a surrounding at a worksite (not shown). Further, the support member 106 may be coupled to the frame 101 of the operator cabin via various methods such as welding, fasteners, bearings, adhesives and the like.

The support assembly 104 includes a seat frame 108 coupled to the support member 106. The seat 100 includes a first armrest 110 and a second armrest 112 coupled to the seat frame 108. The first armrest 110 includes a machine operation controller 114. In the illustrated embodiment, the machine operation controller 114 is a joystick. The machine operation controller 114 may be configured to control various operations of the machine. In an embodiment, the machine operation controller 114 may include a directional controller to steer the machine in a direction of travel. Alternatively, the machine operation controller 114 may also be configured to control a movement of one or more implements coupled to the machine.

The seat 100 includes a base portion 118 defining a longitudinal axis XX″. The base portion 118 is coupled to the seat frame 108. The base portion 118 may be coupled to the seat frame 108 via various methods such as welding, adhesives, fasteners, and the like. The base portion 118 includes a central cushion 119 defining a seating surface 121. The central cushion 119 may have suitable configuration to comfortably seat an operator thereon. Such configurations may include suitable contours and depressions to position the operator and to enhance seating comfort.

The base portion 118 also includes base bolsters 120 disposed on opposing sides of the central cushion 119. In an embodiment, the base bolsters 120 may be coupled to the seat frame 108 and the central cushion 118 such that a shape of the base bolsters 120 may be adjusted. Further, the base portion 120 includes a pair of first bolster bladders (not shown) disposed within each of the base bolsters 120. The first bolster bladders are configured to hold a volume of pressurized air. The first bolster bladders may include any structure, such as a flexible walled structure, configured to hold the volume of pressurized air. Although pressurized air is described, it may also be contemplated that various other fluids may also be used. However, in an alternate embodiment, each of the first bolster bladders may also include an air spring. Further, the shape of the base bolsters 120 may be varied depending on the volume of pressurized air within the first bolster bladders.

The seat 100 further includes a back portion 122 movably coupled to the base portion 118. In the illustrated embodiment, the back portion 122 may be rotatable with respect to the base portion 118 about a transverse axis YY″ perpendicular to the longitudinal axis XX′. The back portion 122 includes a lumbar support member 126 configured to support a back of the operator. The back portion 122 may further include a lumbar bladder (not shown) disposed within the lumbar support member 126. The lumbar bladder may be configured to hold a volume of pressurized air. The lumbar bladders may include any structure, such as flexible walled structure, configured to hold the volume of pressurized air. Although pressurized air is described, it may also be contemplated that various other fluids may also be used. However, in an alternate embodiment, the lumbar bladder may also include an air spring. Further, a shape of the lumbar support member 126 may be varied depending on the volume of pressurized air within the lumbar bladder. Further, the lumbar support member 126 is movable move along the vertical axis ZZ′ perpendicular to both longitudinal axis XX′ and transverse axis YY′. The lumbar support member 126 may be moved along the vertical axis ZZ′ by various actuators (not shown), such as electric motors, hydraulic/pneumatic cylinders, and the like. The seat 100 further includes a headrest 128 coupled to the back portion 122 of the seat 100. The headrest 128 is configured to support a head of the operator.

The back portion 122 further includes a pair of back bolsters 124 disposed on opposing sides of the lumbar support member 126. The back bolsters 124 are coupled to the lumbar support member 126 such that a shape of the back bolsters 124 may be varied. Further, the back bolsters 124 includes a pair of second bolster bladders (not shown). The second bolster bladders may be configured to hold a volume of pressurized air therein. The second bolster bladders may include any structure, such as a flexible walled structure, configured to hold the volume of pressurized air. Although pressurized air is described, it may also be contemplated that various other fluids may also be used. However, in an alternate embodiment, each of the second bolster bladders may also include an air spring. Further, the shape of the back bolsters 124 may be varied depending on the volume of pressurized air within the second bolster bladders.

Further, the seat 100 also includes a temperature control unit (not shown). The temperature control unit may be configured to cool or warm the seat 100 based on a user input. In various applications, the temperature control unit may include heat conducting coils disposed within the seat 100 in order to control the temperature of the seat 100.

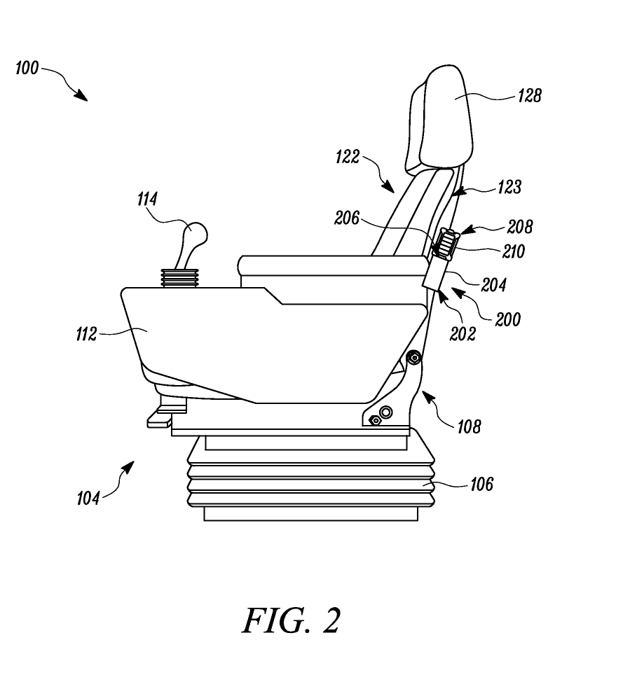

Referring to FIGS. 1 and 2, the control system 200 for the seat 100 is illustrated. The control system 200 is configured to control a component of the seat 100. In the illustrated embodiment, the control system 200 is configured to control the base bolsters 120, the back bolsters 124 and the lumbar support member 126. Further, the control system 200 may also be used to control a temperature of the seat 100 via the temperature control unit.

Although the control system 200 is described to control the base bolsters 120, the back bolsters 124, the lumbar support 126 and the temperature of the seat 100, it may be contemplated that the control system 200 can be used to control other functions of the seat 100, such as fore/aft sliding movement, independent height adjustment, back portion reclining movement, storing positions for one or more operators, adjustable damping functions.

The control system 200 includes a holder 202 coupled to the back portion 122 of the seat 100. In the illustrated embodiment, the holder 202 is coupled to a lateral side 123 of the back portion 122 adjacent to the second armrest 112. However, in various alternate embodiments, the holder 202 may be coupled to any side of the back portion 122 of the seat 100 via various methods such as fasteners, adhesives, welding and the like. In yet another embodiment, the holder 202 may also be attached at any location on the seat 100. For example, the holder 202 may be attached to any of the first armrest 110 and the second armrest 112 such that the holder 202 forms an integral part of a corresponding armrest. The holder 202 further includes a wall 204 defining a cavity 206 therein.

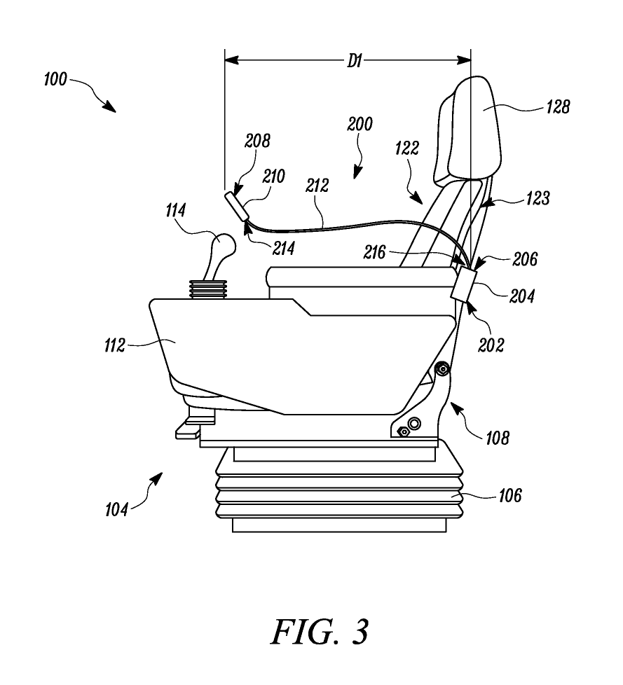

The control system 200 includes a control pod 208 removably and at least partially received within the holder 202. The control pod 208 is adapted to be moved between a storage position (shown in FIG. 2) and a usage position (shown in FIG. 3). The control pod 208 includes a body 210. In the illustrated embodiment, the body 210 has a substantially rectangular shape. However, in various alternate embodiments, the body 210 may be circular, elliptical, oval or any other suitable shape. As shown in FIG. 2, the control pod 208 is partly received within the cavity 206 of the holder 202 in the storage position. Specifically, the body 210 is supported by the wall 204 such that the body 210 projects out of the cavity 206. Hence, the body 210 may be conveniently gripped by the operator and removed from the holder 202.

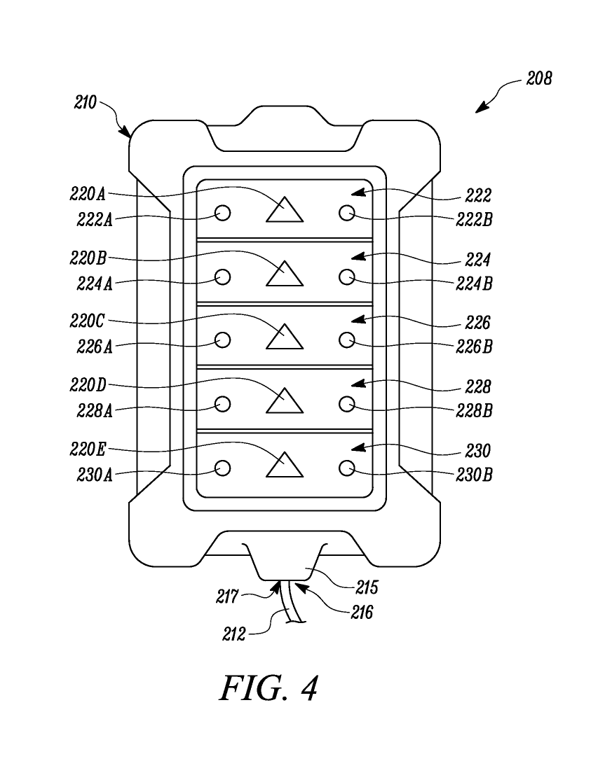

Referring to FIG. 3, the control system 200 includes a cable 212 tethering the control pod 208 and the seat 100 together. In an embodiment, the cable 212 may include one or more electrically conductive members, such as wires, encased within an outer casing. The wires may be configured to transmit signals from the control pod 208 to actuate a corresponding component of the seat 100. Alternatively, the control pod 208 may transmit signals wirelessly to actuate the corresponding component. The cable 212. The cable 212 further includes a first cable end 214 and a second cable end 216. The first cable end 214 is coupled to the control pod 208 via a connecting portion 215 (shown in FIG. 4) of the control pod 208. The connecting portion 215 defines an aperture 217 configured to receive the first cable end 214 of the cable 212. The cable 212 may further be coupled to the connecting portion 215 via various methods such as fasteners, welding, adhesives and the like. In the illustrated embodiment, the second cable end 216 is coupled to the holder 202. In an exemplary embodiment, the seat 100 may also include a spool (not shown) to selectively dispense and reel in the cable 212. Further, the cable 212 may be made of an elastic material.

As shown in FIG. 3, the control pod 208 is disposed outside and spaced apart from the holder 202 in the usage positon. In the illustrated embodiment, the control pod 208 is spaced apart from the holder 202 at a distance ‘D1’. Further, a maximum length ‘L1’ of the cable 212 defines a usage position of the control pod 208 with respect to the seat 100. The usage position, as illustrated in FIG. 3, is purely exemplary in nature, and in various alternative usage positions, the control pod 208 may be disposed anywhere in a region defined by a radius equal to the maximum length “L1” of the cable 212.

The control system 200 also includes a controller (not shown) communicably coupled to the control pod 208. The controller may be configured to receive signals/instructions from the control pod 208 and actuate a component of the seat 100. In an embodiment, the controller may receive signals/instructions and actuate one or more valves associated with a corresponding bladder to increase or decrease a volume of pressurized air therein. Specifically, the controller may selectively regulate a volume of pressurized air within each of the first bolster bladders, the second bolster bladders and the lumbar bladder based on user inputs from the control pod 208. In an example, a compressor may also be provided for pressurizing the air, or other fluid, in the bladders. The controller may communicate, via one or more wires and/or wirelessly, with the control pod 208 to selectively vary a volume of pressurized air within the bladders. In particular, the controller may communicate with one or more valves associated with the bladders to control a flow of pressurized air between a compressor and the bladders. The controller may also actuate a movement of the lumbar support member 126 along the vertical axis ZZ′.

The controller may be an electronic controller that operates in a logical fashion to perform operations, execute algorithms, store and retrieve data and other desired operations. The controller may embody a single microprocessor or multiple microprocessors configured to receive signals from the control pod 208. Numerous commercially available microprocessors may be configured to perform the functions of the controller. A person of ordinary skill in the art will appreciate that the controller may additionally include other components and may also perform other functions not described herein. In an embodiment, the controller may be disposed inside the body 210 of the control pod 208. Alternatively, the controller may be disposed separately from the control pod 208.

The control pod 208 further includes at least one switch disposed on the body 210. Referring to FIG. 4, four such exemplary switches are illustrated. In the illustrated embodiment, the control pod 208 includes five membrane switches 222, 224, 226, 228, 230 countersunk into the body 210. However, in various alternate embodiments, the control pod 208 may include any number of switches depending upon a requirement. Each of the switches is manually actuatable from each of the storage position and the usage position to control a corresponding component of the seat 100.

Further, each of the switches include first ends 222A, 224A, 226A, 228A, and 230A and second ends 222B, 224B, 226B, 228B, and 230B. Each of the switches also includes markings 220A, 220B, 220C, 220D, and 220E disposed between the first ends and the second ends. Each of the markings is indicative of a corresponding component of the seat 100 being actuated. In an embodiment, the marking corresponds to a pictorial image of a corresponding component being actuated. However, in an alternate embodiment, the markings may also include color markings, letter markings or a combination thereof. Further, one or more indicia may also be provided adjacent to the first and second ends to indicate a corresponding control of the switches.

The switch 222 allows an operator to provide an input indicative of varying the shape of the lumbar support member 126. Upon pressing the first end 222A, the controller may actuate a valve to inflate the first lumbar bladder such that a volume of the lumbar support member 126 may be increased. Further, upon pressing the second end 222B, the controller may actuate the valve to release a volume of pressurized air from the first lumbar bladder such that a volume of the lumbar support member 126 may be decreased.

The switch 224 allows the operator to provide an input indicative of movement of the lumbar support member 126. Upon pressing the first end 224A, the controller may move the lumbar support member 126 upwards along the vertical axis ZZ′. Further, upon pressing the second end 224B, the controller may move the lumbar support member 126 towards the base portion 118 along the vertical axis ZZ′.

The switch 226 allows the operator to provide an input indicative of varying the shape of each of the back bolsters 124. Upon pressing the first end 224A, the controller may actuate a valve associated with the second bolster bladders to increase a volume of pressurized air within the second bolster bladders such that volume of the back bolsters 124 may be increased. Further, upon pressing the second end 224B, the controller may actuate the valve to decrease a volume of pressurized air within the second bolster bladders such that volume of the back bolsters 124 may be decreased.

The switch 228 allows the operator to provide an input indicative of varying the shape of each base bolsters 120. Upon pressing the first end 226A, the controller may actuate a valve associated with the first bolster bladders to increase a volume of pressurized air within the first bolster bladders such that volume of the base bolsters 120 may be increased. Further, upon pressing the second end 226B, the controller may actuate the valve to decrease a volume of pressurized air within the first bolster bladders such that volume of the base bolsters 120 may be decreased.

The switch 230 allows the operator to vary a temperature of the seat 100. Upon pressing the first end 230A, the controller may warm the seat 100. Further, upon pressing the second end 230B, the controller may cool the seat 100.

### INDUSTRIAL APPLICABILITY

The present disclosure related to the control system 200 for the seat 100. The control system 200 is configured to control a component of the seat 100. The control pod 208 of the control system 200 includes switches 222, 224, 226, 228, and 230. Each of the switches is further configured to control a corresponding component of the seat 100. The switches are countersunk in the body 210 of the control pod 208 to protect the switches from damage or inadvertent actuation. The body 210 of the control pod 208 can also be ruggedized by using various materials and shapes such that the switches can be protected from damage during operation of the machine. Moreover, shape and dimension of the control pod 208 can be suitably chosen to provide ergonomic and secure handling of the control pod 208 during machine travel. Additionally, functioning of one or more switches can also be selectively enabled or disabled depending on worksite protocols. Further, the cable 212 tethers the control pod 208 and the seat 100 such that the control pod 208 may be moved between the storage position and the usage position. In the usage position, the control pod 208 may be disposed in front of the operator such that the switches are easily accessible. Thus, the operator may control a corresponding component of the seat 100 while controlling the machine.

While aspects of the present disclosure have been particularly shown and described with reference to the embodiments above, it will be understood by those skilled in the art that various additional embodiments may be contemplated by the modification of the disclosed remote operating station without departing from the spirit and scope of what is disclosed. Such embodiments should be understood to fall within the scope of the present disclosure as determined based upon the claims and any equivalents thereof.

What is claimed is:

1. A control system for a seat having a base portion and a back portion, the control system comprising:
a holder coupled to the back portion of the seat;
a control pod removably and at least partially received within the holder, the control pod including:
a body; and
at least one switch disposed on the body, the at least one switch being manually actuatable to control a corresponding component of the seat,
wherein the control pod is adapted to be moved between a storage position and a usage position, wherein the control pod is at least partially received within the holder in the storage position, and wherein the control pod is outside and spaced apart from the holder in the usage position; and
a cable tethering the control pod and the seat together, a maximum length of the cable defining the usage position of the control pod with respect to the seat.
